(19) United States
(12) Patent Application Publication
(10) Pub. No.: US 2011/0081947 A1
(43) Pub. Date: Apr. 7, 2011

(54) INTERACTIVE EVENT GUIDE WITH ENHANCED FEATURES

(76) Inventors: Michael A. Nykoluk, Mississauga (CA); Minh N. Doan, Woodbridge (CA); Sundeep Madra, Toronto (CA)

(21) Appl. No.: 12/993,964

(22) PCT Filed: May 21, 2009
(86) PCT No.: PCT/CA2009/000686

§ 371 Date: Dec. 17, 2010

Related U.S. Application Data
(60) Provisional application No. 61/055,249, filed on May 22, 2008.

(51) Int. Cl. H04N 5/445; H04M 1/00

(52) U.S. Cl. 455/556.1; 725/40

(57) ABSTRACT

A novel interactive event guide system and method which allows users to select events from a set of event listings and to obtain additional information and/or services relevant to the selected events. The additional information and/or services can include access to E-commerce sites offering products related to an event selected from the event listings, access to sites offering additional information relating to products advertised during a selected event and/or products advertised by product placements within a selected event and/or access to social networking services. Demographic information about the user can be provided to an advertiser of a selected event to allow the advertiser to provide appropriate additional information to the user and/or to allow the advertiser to better analyze the success of their advertisement.

### RELATED APPLICATIONS

This application claims priority from U.S. Provisional Patent Application No. 61/055,249, filed May 22, 2008 and the contents of this Provisional Application are incorporated herein, in their entirety, by reference. This application is a

National Phase Entry of PCT/CA2009/000686, the contents of which are incorporated herein, in their entirety, by reference.

### TECHNICAL FIELD

The present invention relates to an interactive event guide. More specifically, the present invention relates to an interactive event guide executing on a handheld communications device, the guide including entries with one or more links to external data and/or services available through the communications capabilities of the handheld communications device.

### BACKGROUND ART

It is known to provide an event guide which provides information relating to various events, such a television programs, television pay per view programs and/or radio broadcasts. For example, set top boxes for digital cable television systems and/or satellite television systems typically provide an event guide which the user can view to determine available programs. With many such guide systems, the user can select a program which is presently being shown and the television will be switched to the appropriate channel to view the selected program.

In some event guides, such as those supplied with personal video recorders (PVRs), if the user selects a program which is not presently being shown, the guide can configure the PVR device to record the selected program when it is shown.

However, while such event guides are useful, they do not provide a number of features which would be desirable. Further, such guides generally require dedicated, purpose built, hardware devices on which the guide is provided and which are shared between users at a location and thus the user must locate and carry or acquire the hardware device to use the guide.

### SUMMARY OF THE INVENTION

It is an object of the present invention to provide a novel interactive event guide system which obviates or mitigates at least one disadvantage of the prior art.

According to a first aspect of the present invention, there is provided an interactive event guide system comprising: an event listing server; a handheld communications device operable to download information from the event listing server and to display a listing of events to a user, the handheld communications device also operable to allow a user to select an option to access additional services relating to an event selected by the user from the displayed listing of events.

Preferably, the additional services comprise information relating to products advertised during the selected event. Also preferably, the additional services comprise providing an option to purchase products advertised during the selected event.

According to another aspect of the present invention, there is provided a handheld communications device implementing an interactive event guide, comprising: a handheld communications device having wireless data connectivity to receive and transmit data, an input device to accept input from a user and an output device to display information to a user, the handheld communications device executing a software application to display to a user event listings downloaded to the handheld communications device via the wireless data connectivity and to allow the user to select an option to access additional services relating to an event selected by the user from the displayed listing of events.

The present invention provides a novel interactive event guide system and method which allows users to select events from a set of event listings and to obtain additional information and/or services relevant to the selected events. The additional information and/or services can include access to E-commerce sites offering products related to an event selected from the event listings, access to sites offering additional information relating to products advertised during a selected event and/or products advertised by product placements within a selected event.

The system and method can also provide access to and participation in social networking services related to selected events. Further demographic information about the user can be provided to advertisers of a selected event to allow the advertisers to provide appropriate additional information to the user and/or to allow the advertisers to better analyze the success of their advertisements.

### BRIEF DESCRIPTION OF THE DRAWINGS

Preferred embodiments of the present invention will now be described, by way of example only, with reference to the attached Figures, wherein:

FIG. 1 shows a schematic representation of a handheld communications device employed with the present invention;

FIG. 2 shows the handheld communications device of FIG. 1 displaying a pop up menu;

FIG. 3 shows the handheld communications device of FIG. 1 displaying a listing of events;

FIG. 4 shows the handheld communications device of FIG. 1 displaying a pop up menus including selections to obtain additional information and/or services;

FIG. 5 shows the handheld communications device of FIG. 1 displaying an E-commerce site;

FIG. 6 shows the handheld communications device of FIG. 1 displaying a listing of advertisers of a program; and

FIG. 7 shows the handheld communications device of FIG. 1 displaying a list of products placed in a program for promotional purposes.

### DETAILED DESCRIPTION OF THE INVENTION

The assignee of the present invention has developed a novel remote control system and method for which U.S. provisional patent application entitled, “Remote Control System and Method”, Ser. No. 61/051,363, was filed on May 8, 2008. A copy of this previous application was incorporated as Appendix A of the above-mentioned U.S. Provisional Patent application from which this application claims priority and the contents of which have been incorporated by reference herein.

In the remote control system and method described in that Appendix A, a handheld communications device, can be a smartphone, such as a Blackberry Curve or Blackberry Bold, manufactured by Research in Motion, or an iPhone manufactured by Apple. While there is no generally accepted standard definition of a smartphone, as used herein the term smartphone is intended to comprise any mobile telephone which can provide data connectivity, an ability to execute software applications, an application display (typically a LCD screen or the like) and an input mechanism (typically a keyboard, touchscreen, trackball, etc).

In the remote control system and method, the handheld communications device is employed in conjunction with a command server, account server and other components to form the remote control system. The handheld communications device executes a software application which implements a remote control user interface and functionality on the handheld device. The handheld communications device then, in response to user selections and inputs, sends control commands to the command server. The command server responds to the received control commands by transmitting corresponding command signals to the device or devices being controlled by the remote control system.

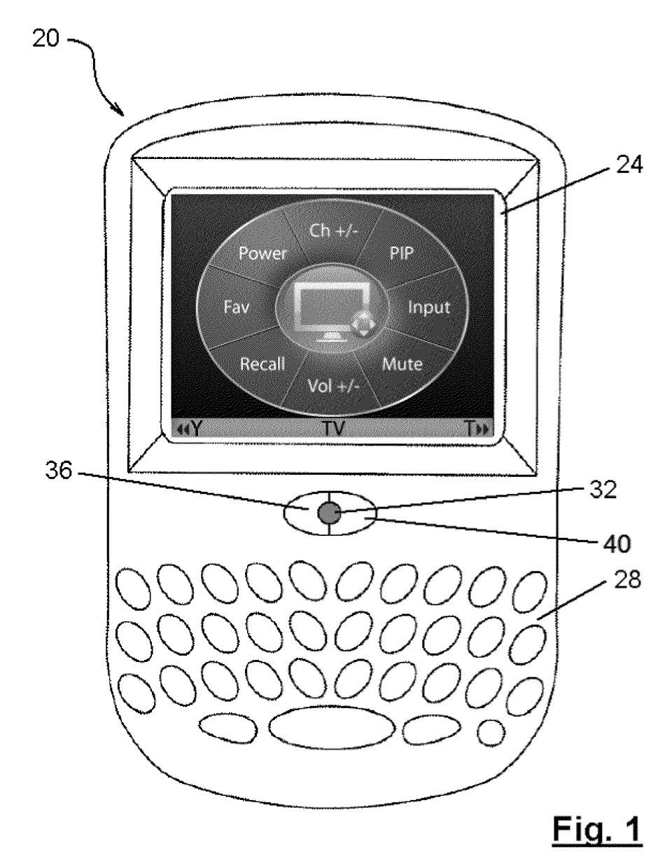

An example of a handheld communications device for use with the present invention is indicated at 20 in FIG. 1 wherein handheld communications device 20 is a Blackberry® smartphone, manufactured by Research In Motion. Handheld communications device 20 includes a communications capability which permits handheld communications device 20 to receive and transmit data via a data communications network, such as the Internet. Preferably, this communications capability allows handheld communications device 20 to communicate directly with the data communications network, although it is also contemplated that handheld communications device 20 can alternatively communicate with the data communications network indirectly, for example via a WiFi link to an access point in communication with the data communications network.

An application program, implementing the features of the event guide described herein, can be preloaded into handheld communications device 20 or can be downloaded into handheld communications device 20 via the data communications network. It is contemplated that the application program need only be preloaded or downloaded once, but that updates and enhancements can be loaded into handheld communications device 20 as desired. It is further contemplated that the application program will commonly be loaded on to handheld communications device 20 as a component of the application implementing the remote control application of the remote control system but, as will be apparent to those of skill in the art, the application can be downloaded as a stand alone application and can be utilized without requiring the presence or use of the remote control system.

Data for the event guide, described below, is transferred to handheld communications device 20 from an appropriate event listing server via the data communications network. Further, as described below, data from handheld communications device 20 can be transmitted, via the data communications network, to one or more servers, web sites or other devices and/or locations as described further below.

Assuming that the event guide is being used with the remote control system, the user of the handheld communications device 20 interacts with the display 24 and keyboard 28 (or touchscreen, if present—but not shown in the illustrated example) and pointing device 32, such as a track ball, of the handheld communications device 20 to operate the remote control system. In FIG. 1, handheld communications device is executing the remote control application and display 24 is showing a screen relating to the control of a television set, and related components, with handheld communications device 20.

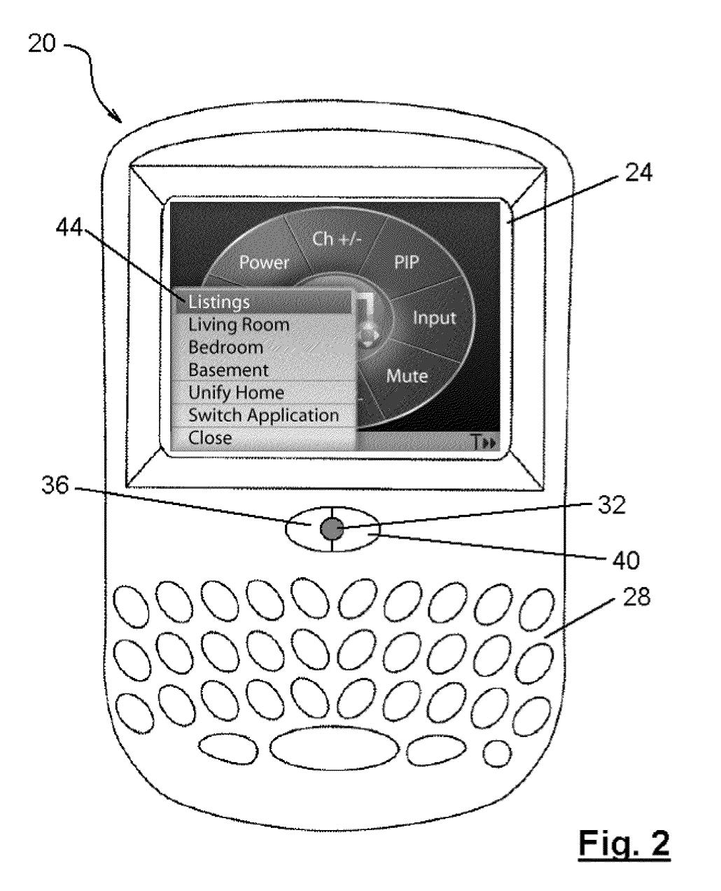

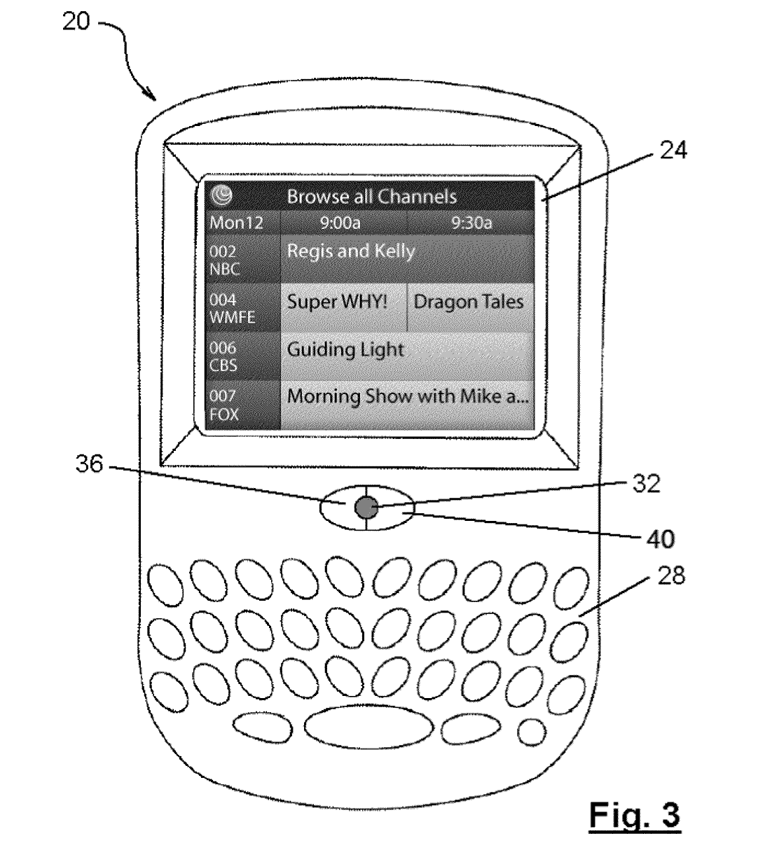

In FIG. 2, the user has activated a pop up menu 44 (by pressing an appropriate key on keyboard 28 or by pressing one of the two keys 36 and 40 associated with pointing device 32) which provides an option to use the even guide to view television program listings. When the user selects the listings option, in any appropriate manner, such as with pointing device 32 and button 36, the event guide is invoked and television listings are displayed to the user on display 24 as shown in FIG. 3.

When the television listings are first requested, the displayed events are those presently being broadcast, as determined from a real time clock in handheld communications device 20 or by any other suitable manner, as will occur to those of skill in the art. In the illustrated example of FIG. 3, the present time is 9:00 AM and listings of the events (i.e.—programs) being broadcast at that time are displayed to the user. Preferably, to provide a near immediate display of listings for the user, these listings have been previously downloaded to handheld communications device 20, via the data communications network, and cached in memory in handheld communications device 20.

Depending upon the amount of available memory in handheld communications device 20, different amounts of data for television show listings can be downloaded and cached in handheld communications device 20. For example, prime time listings for an entire week of television programs can be downloaded and appropriately cached in handheld communications device 20.

It is presently preferred that some amount of listings, such as the above-mentioned example of a week's worth of prime time listings, are automatically and regularly downloaded and cached in handheld communications device 20. For example, at some pre-selected time in each day, another day's prime time listings can be proactively downloaded, as can the non-prime time listings for the present day while previously downloaded listings for previous days can be removed to free storage space in handheld communications device 20.

It is also contemplated that selections of listings can be proactively downloaded to handheld communications device 20 based upon a user's prior patterns of use. For example, a user who works a night shift and thus does most of their television watching in the morning could have the listings for morning television shows downloaded to handheld communications device 20, rather than prime time listings. In such a case, the event guide application will maintain a record of the times it is invoked by a user and will select the listings to be proactively downloaded and will set an appropriate pre-selected time to download those listings.

In any case, any desired listings which have not been previously downloaded and cached on handheld communications device 20 can be downloaded, via the data communications network, as needed, albeit with some delay.

A user can scroll though the listings (using pointing device 32 and/or keyboard 28) and/or search the listings to review available programs and/or to select a program.

If handheld communications device 20 is part of the remote control system and if the user selects a program which is presently being broadcast from the listings, the remote control system can control the television (turn on the TV if it is not already on, change the channel to the channel for the selected program, etc.) so that the selected program is displayed on the television. Alternatively, if the user selects a program which is not yet being broadcast, the remote control system can offer the option to program the user's PVR to record the program when it is displayed and/or, in the event that the user does not have a PVR, handheld communications device 20 can create a reminder alarm which will be triggered on handheld communications device 20 to remind the user of the program a pre-defined time period before the broadcast of the program commences.

In addition to the above features, the present invention provides several significant additional features. In particular, as handheld communications device 20 includes the capability of transmitting and receiving data via the data communications network, the present invention offers the ability to interactively enjoy and view a program in novel manners.

One feature offered by the present invention is the ability to provide links to web sites or other Internet based applications which are specific, or related, to a user selected program. These links, applications and/or information associated with the enhanced features of the present invention are included with the event information downloaded to handheld communications device 20 from the event listing server via the data communications network.

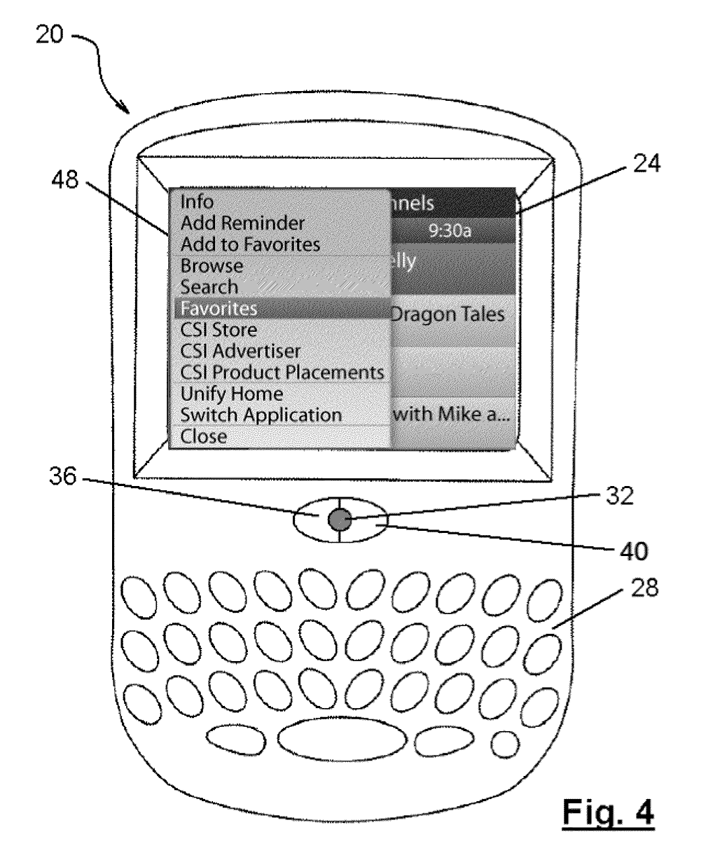

For example, as shown in FIG. 4, the user has selected a program (in this example, the television program “CSI” has been selected) and has invoked a pop up menu 48 which includes one or more entries related to the selected program. In the illustrated example, these entries include, “CSI Store”, “CSI Advertisers” and “CSI Product Placements”.

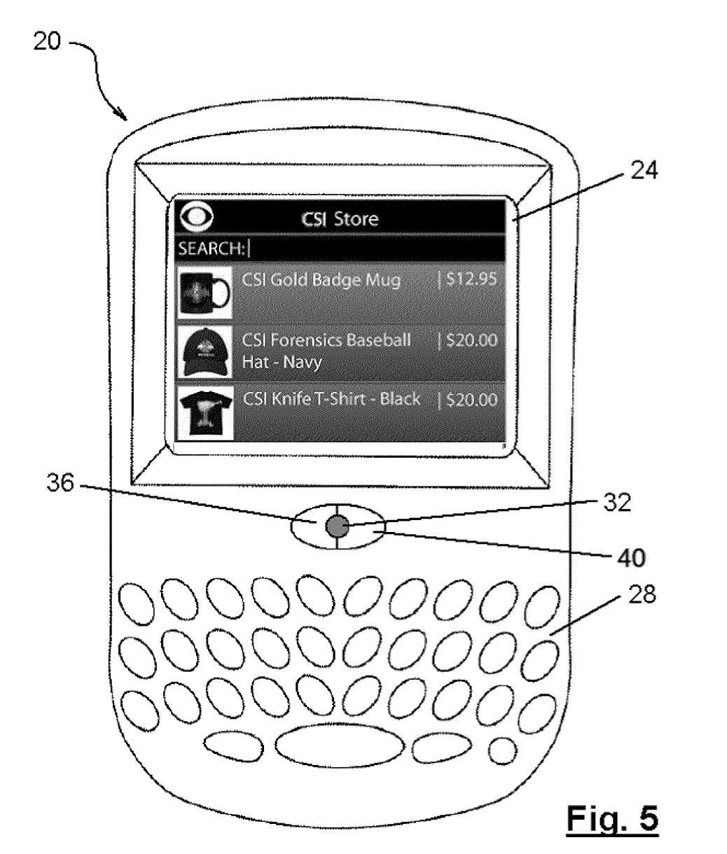

If the user selects the “CSI Store” entry, handheld communications device 20 can invoke a web browser, which is shown on display 24, and which communicates, via the data communications network, with an E-commerce enabled web site selling merchandise associated with the selected program as shown in FIG. 5. In this manner, a user can select a program, visit the E-commerce web site associated with that program and interact with that site to purchase items related to the show such as clothing with appropriate logos, downloads or DVD's of previous season's episodes, etc.

Preferably, payment for goods purchased from such E-commerce sites is effected by way of an account, previously established for the user of handheld communications device 20, with the provider of the remote control service and system. Further, as part of the set up of this account, the user can define a shipping address for products purchased online that will be shipped and/or a computer device to which purchased downloads will be transferred. In this manner, a user preferably can quickly and easily purchase items from the E-commerce site without undue worry about fraudulent misuse by others, as purchased goods will only be delivered to the pre-defined address or computing devices.

Thus, a user can make a purchase merely by pressing a “Buy Now” (or similar) button and (if desired) responding affirmatively to a “Confirm Your Purchase?” prompt. It is believed that this system will provide an enhanced degree of purchasing from the event related E-commerce sites as “impulse” purchases can easily be completed.

Alternatively, purchase and payment can be effected via an account previously established with the carrier providing the data communications network services, or via a credit card, e-payment system, such as PayPal, etc. with conventional input of delivery information.

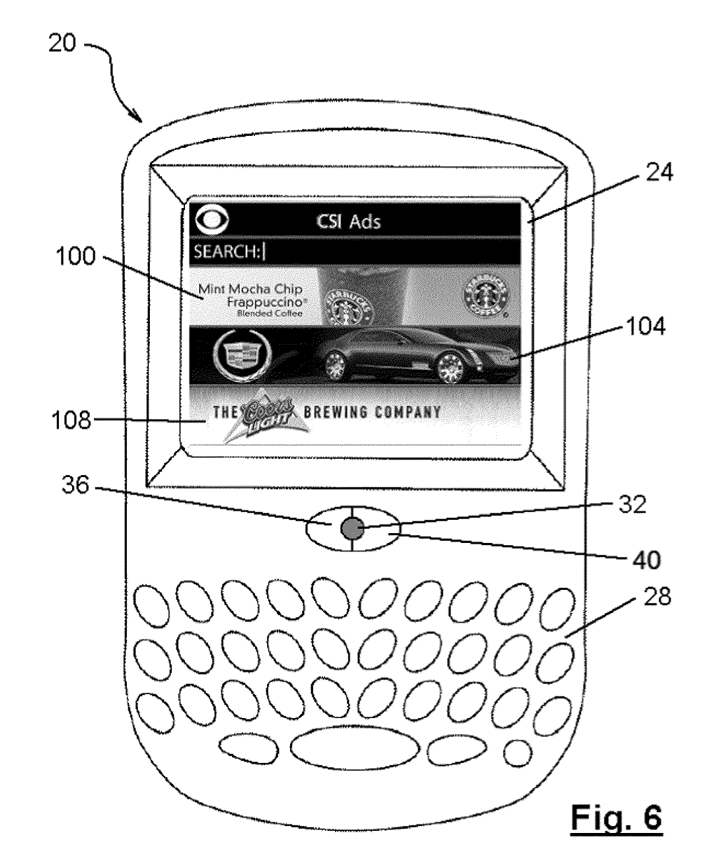

Returning to the consideration of FIG. 4, if the user selects “CSI Advertisers”, handheld communications device 20 can invoke a web browser on display 24, as shown in FIG. 6, which communicates, via the data communications network, with a web site which provides additional information, and/or links to, advertisers who have advertised during the broadcast of the selected program. In the example shown in FIG. 6, if a user selects a displayed entry for Starbucks® 100, Cadillac® 104 or Coors® 108, the web browser will connect to a web site which provides more information about the selected product.

Thus, if a user was interested in a product advertised during the selected program, they can easily and conveniently obtain additional information on that product. If the advertised product can be purchased via a web browser, then the option to purchase the product can also be offered to the user from the web site.

Further, as the connection to the advertiser web site is performed by handheld communications device 20, at the request of the user, it is also contemplated that advertisers can be provided information by handheld communications device 20 or by the remote control system, informing them of the origin of that connection. Specifically, it is contemplated that the advertiser can be informed that someone who watched “CSI” (or another selected program) followed up on their advertisement to obtain additional information and/or to make a purchase.

It is contemplated that such information can be used by advertisers to determine the success of their advertisements broadcast during particular shows and/or by the broadcaster to appropriately price advertising time for particular shows.

Further, as the remote control system and method requires a user to establish a user account before they can use the remote control service, the remote control system has a variety of demographic information about the user (including, at a minimum, that they own a handheld communications device 20 and the devices, such as television sets, etc., that they operate with it and the shows they typically watch). Subject to privacy laws and other constraints, handheld communications device 20 can provide some subset of this demographic information to advertisers so that they may better understand their success, or lack of success, with particular demographic groups and/or with particular programs.

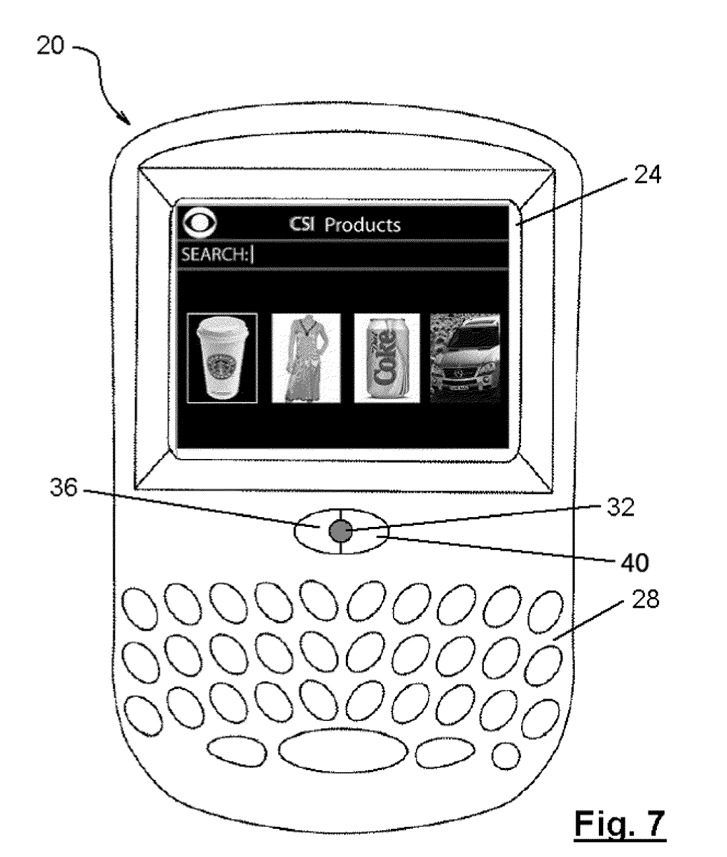

If the user selects “CSI Product Placements”, handheld communications device 20 can invoke a web browser, as shown in FIG. 7, which communicates, via the data communications network, with a web site which provides additional information about products shown in the program as a result of a product placement or promotional fee paid by the product manufacturer.

As was the case with the above-described “CSI Advertisers” choice, additional information about the products and/or purchase options can be provided to the user who selects one of the displayed products as the web browser will connect to an appropriate web site which provides more information about the selected product. Also, the above-mentioned demographic information can be provided to the advertisers and/or the broadcasters when a user views product placement information.

It is believed that such product placement services may be particularly useful for products which are shown in a program but which have no obvious display of trademark or brand within the program. For example, clothing and furniture can be placed in a program and no explicit brand or other identifier will be apparent to a viewer. However, if a viewer selects the program from the listings and then selects “CSI Product Placement”, the web site which the user is directed to can provide a variety of information with respect to such products.

Preferably, handheld communications device 20 can support “push” technologies wherein a variety of information can be downloaded to handheld communications device 20 via the data communications network without requiring specific action on the part of a user. In such a case, it is also contemplated that, during the display of their advertisements during a selected program, advertisers can display dynamic information comprising additional related information on display 24. For example, during the broadcast of an advertisement for an automobile on the channel for the selected program, relevant related information for that automobile can be downloaded to handheld communications device 20 and displayed on display 24. Such relevant information can be, for example, pricing information for the advertised product relevant to the viewing location (as determined from the account set up) of the user, additional specifications for the product, an option to purchase the product, an option to have additional information emailed to an email account (previously defined during the user set up operation) for the user, etc.

Further, if push technologies are supported, dynamic information about products in product placements in a selected program can be pushed to handheld communications device 20, and displayed on display 24, when the product is shown in the broadcast program. Thus, for example, if an actress walks into a scene in the program wearing a product placement dress, the details of that dress can be pushed to handheld communications device 20 and displayed on display 24 when the actress enters the scene. The displayed information can include an identifier (brand, trademark, model number, etc.) for the product as well as information as to where to buy the product, an option to purchase the product and/or a link to the manufacturer's web site, etc.

As another feature of the present invention, the event listings and data can include links to social networking features. For example, when watching “CSI” a user can select from the event listing a prompt to join an instant messaging session related to the CSI program wherein other fans watching the program can exchange thoughts, opinions or information. In such a case, the instant messaging session can be implemented via built in functionality of handheld communications device 20 or via additional software functionality provided in the event guide software application.

As will be apparent tot hose of skill in the art, the social networking features of the present invention are not limited to instant messaging and other social networking services and features related to the selected program and implemented over the Internet, such as discussion forums, Twitter sessions and Facebook and/or MySpace sessions, can be offered.

As another feature of the present invention, handheld communications device 20 can monitor which program a user is presently watching (as the program was selected from listings on handheld communications device 20 and/or the input on the television set was selected with handheld communications device 20). This information can be reported back, through the data communications network, to an advertising server operating as part of the remote control system and method. Based upon the reported information and/or demographic information about the user known to the remote control system, the advertising server can select and push one or more banner advertisements, or the like, to handheld communications device 20 for display on display 24. For example, if a user is watching CSI, the advertising server can push a banner ad to handheld communications device 20 offering DVDs of the latest season of CSI for sale.

While the discussion above has only made reference to television programs as the events in the event guide, the present invention is not so limited and it is contemplated that the present invention can be employed with a wide range of events. For example, the present invention can be employed with an event guide which, either instead of or in addition to television program listings, can feature radio broadcast programs or social events such a music concerts, etc.

The present invention provides a novel interactive event guide system and method which allows users to select events from a set of event listings and to obtain additional information and/or services relevant to the selected events. The additional information and/or services can include access to E-commerce sites offering products related to an event selected from the event listings, access to sites offering additional information relating to products advertised during a selected event and/or products advertised by product placements within a selected event. Demographic information about the user can be provided to an advertiser of a selected event to allow the advertiser to provide appropriate additional information to the user and/or to allow the advertiser to better analyze the success of their advertisement.

The above-described embodiments of the invention are intended to be examples of the present invention and alterations and modifications may be effected thereto, by those of skill in the art, without departing from the scope of the invention which is defined solely by the claims appended hereto.

We claim:

1. An interactive event guide system comprising:
an event listing server;
a handheld communications device operable to download information from the event listing server and to display a listing of events to a user, the handheld communications device also operable to allow a user to select an option to access additional services relating to an event selected by the user from the displayed listing of events.

2. The system of claim 1 wherein the additional services comprises making available information relating to products advertised during the selected event.

3. The system of claim. 1 wherein the additional services comprise providing an option to purchase products advertised during the selected event.

4. The system of claim 1 wherein the additional services comprises access to social networking services implemented over the Internet.

5. The system of claim 1 wherein the event listings relate to television programs.

6. The system of claim 1 wherein the handheld communications device is operable to forward information representing the interactions of the user with the handheld communications device to the event listing server.

7. The system of claim 1 wherein the event listing server maintains demographic information relating to the user.

8. The system of claim 1 wherein the handheld communications device is a mobile telephone.

9. The system of claim 1 wherein the event listing server pushes data to the handheld communications device to provide dynamic information during the selected event.

10. A handheld communications device implementing an interactive event guide, comprising:
a handheld communications device having wireless data connectivity to receive and transmit data, an input device to accept input from a user and an output device to display information to a user, the handheld communications device executing a software application to display to a user event listings downloaded to the handheld communications device via the wireless data connectivity and to allow the user to select an option to access additional services relating to an event selected by the user from the displayed listing of events.
